(19) United States
(12) Patent Application Publication
(10) Pub. No.: US 2022/0144610 A1
(43) Pub. Date: May 12, 2022

(54) INDUSTRIAL TRUCK

(71) Applicant: HUBTEX MASCHINENBAU GMBH & CO.KG, FULDA (DE)

(72) Inventor: JUERGEN KELLER, GROSSENLUEDER (DE)

(73) Assignee: HUBTEX MASCHINENBAU GMBH & CO.KG, FULDA (DE)

(21) Appl. No.: 17/601,925

(22) PCT Filed: Mar. 12, 2020
(86) PCT No.: PCT/EP2020/056610

§ 371 Date: Oct. 7, 2021

(30) Foreign Application Priority Data
Apr. 11, 2019 (DE) 10 2019 109 594.8

(51) Int. Cl. B66F 9/10; B66F 9/07; B66F 9/14; B66F 9/18; B65G 1/04

(52) U.S. Cl. CPC B66F 9/10; B66F 9/07; B65G 1/0435; B66F 9/181; B66F 9/141

(57) ABSTRACT

An industrial truck includes a base chassis, a rigid transport frame having at least one transport platform on which goods are transportable and at least one supporting beam which is arranged above the at least one transport platform, a lifting apparatus which raises, lowers and laterally shifts the rigid transport frame, and a moving apparatus which raises, lowers and laterally shifts the goods at least relative to the rigid transport frame. The moving apparatus is mounted on the at least one supporting beam.

### CROSS REFERENCE TO PRIOR APPLICATIONS

This application is a U.S. National Phase application under 35 U.S.C. § 371 of International Application No. PCT/EP2020/056610, filed on Mar. 12, 2020 and which claims benefit to German Patent Application No. 10 2019 109 594.8, filed on Apr. 11, 2019. The International Application was published in German on Oct. 15, 2020 as WO 2020/207692 A1 under PCT Article 21(2).

### FIELD

The present invention relates to an industrial truck, in particular to an order picker.

### BACKGROUND

Industrial trucks or fork-lift trucks are used to store and retrieve loading units, in particular goods arranged on a pallet or on a shelf, and have previously been described. Special designs of the industrial trucks can also be used for order picking, in which selected subsets of goods are put together. The storage and retrieval of subsets is usually performed manually by an operator or driver of the industrial truck. In the case of larger and particularly heavy goods, such as wooden or metal panels, the storage and retrieval can also be carried out using technical aids. It should be clear that, in the present case, the term “goods” also means a single item of goods, such as a single panel, and that the plural is only used for improved readability.

In order to simplify the storage and retrieval of partial quantities for the operator and to improve safety when working at great heights and with large or heavy goods, various technical proposals for suitable aids have previously been described, which mainly relate to ergonomic improvements to the operating platform.

DE 10 2006 029 759 A1, for example, describes an order picker in which a driver's seat can be raised in order to allow an operator to sit in an ergonomically favorable position both with direct access to goods to be stored or retrieved and when driving the order picker. It is, however, here disadvantageous that the storage and retrieval of individual quantities of goods due to the manual use of the operator is still relatively time-consuming and, in particular, that the picking of large components, such as door elements, is relatively complicated and laborious.

DE 30 46 027 A1 describes a fork-lift truck having a lifting fork apparatus and a crane apparatus which is arranged above and which is separately movable. The crane apparatus can in particular be raised, lowered, and laterally shifted via a support arm with respect to the lifting fork apparatus. The disadvantage here is, however, that particularly heavy goods and/or goods stored at great heights can only be picked up to a limited extent in order to prevent the fork-lift truck from tipping over. The field of vision of an operator, in particular during an order-picking process at a great height, is also severely restricted and consequently a positionally accurate gripping or depositing of the goods is relatively cumbersome and time-consuming.

### SUMMARY

An aspect of the present invention is to provide an industrial truck which improves on at least one of the above-mentioned disadvantages and which in particular allows for the safe and uncomplicated picking of large components.

In an embodiment, the present invention provides an industrial truck which includes a base chassis, a rigid transport frame comprising at least one transport platform on which goods are transportable and at least one supporting beam which is arranged above the at least one transport platform, a lifting apparatus which is configured to raise, to lower and to laterally shift the rigid transport frame, and a moving apparatus which is configured to raise, to lower and to laterally shift the goods at least relative to the rigid transport frame. The moving apparatus is mounted on the at least one supporting beam.

### BRIEF DESCRIPTION OF THE DRAWINGS

The present invention is described in greater detail below on the basis of embodiments and of the drawings in which:

FIG. 1 is a perspective view of an industrial truck according to the present invention;

FIG. 2 is a perspective view of a transport frame of the industrial truck;

FIG. 3 is a side view of the industrial truck with an extended moving apparatus;

FIG. 4 is a side view of the industrial truck with a laterally shifted moving apparatus;

FIG. 5 is a side view of the industrial truck with a laterally shifted moving apparatus;

FIG. 6 is a top view of the industrial truck with a laterally extended moving apparatus and fork device;

FIG. 7 is a first front view of the industrial truck during an order-picking process;

FIG. 8 is a second front view of the industrial truck during an order-picking process; and

FIG. 9 is a third front view of the industrial truck during an order-picking process.

### DETAILED DESCRIPTION

The industrial truck according to the present invention comprises a base chassis, a rigid transport frame which has at least one transport platform on which goods can be transported and at least one supporting beam, which is arranged above the transport platform, a lifting apparatus for raising, lowering, and laterally shifting the transport frame, and a moving apparatus for raising, lowering, and laterally shifting the goods at least relative to the transport frame, the moving apparatus being mounted on the supporting beam. The storage and retrieval process can thereby be simplified and accelerated, in particular when picking particularly large and/or heavy goods. It can also be provided that an operator always has a clear view of the goods to be picked up or deposited.

The base chassis comprises a frame or chassis which, as a rule, stands on four wheels and is movable in a driven manner so that the industrial truck can move and maneuver freely between high racks, in particular in internal corridors. The industrial truck is generally operated in a main direction of travel that is defined in the longitudinal extension of the chassis and substantially lies in a horizontal plane. In order to achieve a high degree of freedom of movement for the industrial truck when driving, all the wheels of the industrial truck can be mounted so as to be pivotable by a steering angle of at least 90°, for example, at least 180°, for example, 360°. As an alternative or in addition thereto, the base chassis can be guided between two planks or bound in a rail or groove, in particular when traveling between two shelf walls, and can thus be safely guided during the movement.

At least one lifting mast or lifting frame, which extends substantially in the vertical direction, is arranged on the base chassis. The lifting apparatus of the transport frame is arranged on the lifting mast. The lifting apparatus in particular comprises a part which can be moved in height along the lifting mast and to which the transport frame is fixed in the present case. Via the lifting apparatus, the entire transport frame can therefore be shifted to a height which is suitable for storing and retrieving goods, which is in particular advantageous in the case of high racks. The entire transport frame can also, for example, be shifted laterally relative to the base chassis via the lifting apparatus. When the industrial truck is operating between two shelf walls and when a shelf compartment is approached for order picking, the transport frame can as a result, for example, be shifted in the direction of the shelf compartment so that the distance between the shelf space and the transport frame is reduced and safety is thus increased.

The transport frame, which is also referred to as a transport bridge, can be designed as a three-dimensional chassis that spans a space. For this purpose, the transport frame can in particular have the transport platform, at least one support or wall extending upward from the transport platform, and at least one supporting beam which is, for example, arranged on the support or wall.

The supporting beam is usually aligned horizontally and is arranged above the transport platform, in particular at a distance so that an operator can stand upright on the transport platform. The transport beam is in particular designed to be immovable with respect to the transport platform. The supporting beam can in particular form a ceiling of the space spanned by the transport frame or be part of such a ceiling, for example, as a ceiling structure. In the case of a transport frame designed as a rectangle, in particular four supports, which are usually arranged in the corner regions of the transport platform, or alternatively, two end walls and at least two supporting beams aligned in the longitudinal extension of the support frame, can be provided, the transport frame advantageously being aligned in the longitudinal extension thereof, in this case, in the longitudinal extension of the base chassis.

The transport platform can be designed as a substantially horizontal surface on which the goods to be transported can be deposited. The goods can be stored on a transport pallet or picked directly on the transport platform without transport aids. For the latter case, the transport platform can in particular also serve as a work platform on which the operators of the industrial truck can stay.

The loading and unloading of the transport platform in particular takes place laterally transversely to the main direction of travel of the industrial truck. In order to make the loading and unloading process safe and uncomplicated, for example, in the case of a high rack, the transport frame can be raised via the lifting apparatus so that the transport platform is arranged at the same height as the shelf compartment intended for the goods to be stored or removed. The transport frame and in particular the transport platform can furthermore be laterally shifted in the direction of this shelf compartment with respect to the base chassis so that the transport frame can be positioned particularly close to the shelf compartment. The transport frame has on the sides, in particular in the regions in which loading and unloading of the transport platform can take place, for example, no or an adjustable side border, such as a grille or railing, so that the goods can be loaded in an unobstructed manner from a shelf compartment to the transport platform or can be reloaded in an unobstructed manner from the transport platform into a shelf compartment. The industrial truck has the moving apparatus in order to simplify and accelerate this work step.

The moving apparatus for raising, lowering, and laterally shifting the goods, at least relative to the transport frame, is mounted on the supporting beam of the transport frame which is arranged above the transport platform and which can accordingly pick up and deposit goods, in particular from above. The moving apparatus can in particular be separately controllable and designed as a load carrier, which can be moved at least to one side, in particular beyond the fork-lift contour, for lateral shifting. Goods to be arranged on the transport platform or in a shelf compartment can in this way, for example, be stacked on top of one another in a particularly simple manner. This is in particular advantageous when picking large goods such as wooden panels or doors which are mostly stacked on top of one another with their flat sides. For example, after the industrial truck has approached the relevant shelf compartment via the moving apparatus, an item of goods located in the shelf compartment can, for example, be picked up by the moving apparatus from above, in particular raised, and shifted out of the shelf in the direction of the transport platform, in particular carried, and be deposited on the transport platform. The moving apparatus can advantageously have both a device for laterally shifting the goods and a device for carrying and holding the goods for this purpose. The moving apparatus can, for example, have at least one movement support arm for laterally shifting and at least one gripping device arranged on the movement support arm for holding and carrying the goods. The shifting, i.e., moving to the side, in particular in a horizontal plane, can be made possible in a plurality of spatial directions, for example, in the direction of the longitudinal extension of the base chassis, in particular over at least one longitudinal portion of the supporting beam, and in the direction transverse or perpendicular thereto. It should be clear that the present expression “at least relative to the transport frame” means that the movement can also take place simultaneously relative to the rest of the vehicle, in particular the base chassis, and a shelf.

The moving apparatus can, for example, have a boom lifting gripper with a load pick-up device for picking up and depositing goods. The boom lifting gripper can in particular be designed to be suitable for raising, lowering, and laterally shifting goods, in particular from a structural and functional point of view, as already described in detail above for the moving apparatus. The load pick-up device arranged on the boom lifting gripper can, for example, have a device for holding and carrying the goods, i.e., for temporarily fixing the goods on the boom lifting gripper, and in particular can be controlled separately. The boom lifting gripper can, for example, comprise two opposing gripping arms between which the goods can be clamped and thus held in a clamped manner. The load pick-up device can, for example, have a suction unit with suction cups for carrying the goods via negative pressure. The suction cups can advantageously be placed on a flat surface of the goods, such as an upper side, and thereby hold the goods on the load pick-up device in a manner which is known per se, forming negative pressure. The goods fixed on the load pick-up device via negative pressure can as a result be raised, lowered, and laterally shifted via the boom lifting gripper in a particularly safe and simple manner.

As already mentioned above, the moving apparatus, in particular the boom lifting gripper of the moving apparatus, can have a device for laterally shifting the goods, the moving apparatus additionally being, for example, suitable for raising or lowering the goods relative to this device. The device for laterally shifting the goods can, for example, be designed as a support rail device. The support rail device can have at least one support rail, such as a telescopic fork or arm, which is displaceable and/or adjustable in length, in particular in the horizontal direction. The moving apparatus can as a result be constructed in a particularly space-saving manner. A first end of the support rail device can, for example, be attached to the transport frame, the other, in particular the second end of the support rail device facing the goods to be carried, can be relatively movable, in particular into a laterally offset position. The moving apparatus can also have a device for raising or lowering the goods relative to the shifting device, i.e., relative to the support rail device in the present example. A load pick-up device can in particular be shifted in height for picking up and depositing goods, in particular without shifting the height of the movement device, such as a support rail or support rail device. For storing or retrieving goods, the transport frame can, for example, first be movable to a shelf compartment height and then the entire boom lifting gripper can be movable from a first operating position in which the boom lifting gripper is surrounded by the transport frame, for example, via the at least one support rail, into a second operating position in which, for engaging in a shelf compartment, the boom lifting gripper is arranged so as to protrude at least partially, in particular laterally, beyond the contour of the transport frame or so as to project from the transport frame. In this second operating position, the boom lifting gripper can raise or lower the load pick-up device relative to the support rail device for picking up or depositing goods. During such an order-picking process, the transport frame can as a result be approached at substantially the same height as the shelf compartment carrying the goods so that a particularly good overview for an operator, in particular a clear field of vision for gripping or depositing goods on a laterally arranged shelf, is made possible. A permanently unobstructed view of the region surrounded by the transport frame above the transport platform is furthermore made possible, so that the order-picking process can take place particularly safely overall.

The moving apparatus can, for example, comprise a ceiling lifting device and a boom lifting gripper, the ceiling lifting device being suitably designed for raising, lowering, and laterally shifting at least the boom lifting gripper, and the goods optionally held thereon, and the boom lifting gripper being suitably designed for additional raising, lowering, and laterally shifting the goods. The ceiling lifting device can, for example, be arranged rigidly or displaceably on the supporting beam of the transport frame and allow a first raising or a first raising height of the goods. The ceiling lifting device can furthermore be mounted shiftably or displaceably in a first direction, for example, in the longitudinal extension of the base chassis. The boom lifting gripper can allow for a second raising or a second raising height of the goods, which can in particular correspond to the first raising height in terms of magnitude. The boom lifting gripper can furthermore be mounted shiftably or displaceably in a second direction, for example, in the transverse extension of the base chassis. This allows for goods to be stored and retrieved particularly quickly. An additional raising and shifting of the goods with respect to the transport frame and/or with respect to the ceiling lifting device can furthermore in particular be effected using the boom lifting gripper.

The ceiling lifting device can, for example, be mounted on the at least one supporting beam and the boom lifting gripper is mounted on the ceiling lifting device. The ceiling lifting device can in particular be mounted in an upper side region on the supporting beam of the transport frame and the boom lifting gripper on a load pick-up device of the ceiling lifting device, in particular arranged in a lower side region of the ceiling lifting device.

The ceiling lifting device can, for example, be moved at least relative to the transport frame in the direction of the longitudinal extension of the base chassis and the boom lifting gripper can be moved at least relative to the transport frame in the direction of the transverse extension of the base chassis. The ceiling lifting device can in particular be movably mounted in the manner of a bridge crane, for example, on two spaced-apart, parallel supporting beams, in particular in each case on a rail on the supporting beam, it being possible for a recess to be formed between the supporting beams, between and below which the ceiling lifting device is arranged, at least in sections. The goods can thereby be deposited on the transport platform or picked up by the transport platform along an elongated transport frame in different positions in the longitudinal extension. The goods can thereby be positioned on the transport frame distributed over the entire length of the latter and can therefore be transported in a particularly advantageous manner. The boom lifting gripper, on which the goods can be held and carried on the moving apparatus via a load pick-up device, can be used for storage and retrieval in or from a shelf compartment, in particular be shifted in the direction transverse to the longitudinal extension of the base chassis, in particular in a shelf compartment located laterally next to the vehicle.

The ceiling lifting device and the boom lifting gripper can, for example, each have a scissor lifting device, in particular for raising and lowering a corresponding load pick-up device, at least relative to the transport frame. The ceiling lifting device can in particular be used to raise and lower the boom lifting gripper, which can, for example, be mounted on the load pick-up device of the ceiling lifting device, relative to the transport frame, and the boom lifting gripper can be used to raise and lower the goods which are, for example, stored on the load pick-up device of the boom lifting gripper relative to the ceiling lifting device. In the case of the ceiling lifting device, in particular an upper part of the scissor lifting device can be mounted on the supporting beam of the transport frame and on a lower part of the scissor lifting device of the boom lifting gripper that can be moved, in particular lowered, relative to the upper part. In the case of the boom lifting gripper, in particular an upper part of the scissor lifting device can be mounted on the ceiling lifting device and a load pick-up device for picking up goods can be arranged on a lower part of the scissor lifting device that can be moved, in particular lowered, relative to the upper part. This allows for a particularly space-saving lifting device which in particular allows an operator to have a permanently clear view of the goods to be transported and/or picked.

The transport frame mounted on the base chassis can, for example, be moved at least laterally relative to the base chassis. The transport frame can thereby be brought particularly close to a shelf compartment during an order-picking process so that a gap between the transport frame and the shelf compartment is minimized and, as a result, work safety is increased.

The at least one supporting beam can, for example, be arranged via at least one support at a specific distance above the transport platform and is rigidly connected to the transport platform. A particularly stiff and rigid transport bridge can thereby be provided which allows a particularly large number of heavy goods to be transported and thus simplifies and accelerates the picking of a plurality goods.

The lifting apparatus arranged in particular on the base chassis can advantageously have a first lifting mast and a second lifting mast arranged opposite thereto in the longitudinal extension of the vehicle, and the transport frame can be arranged between the first lifting mast and the second lifting mast. This allows for a particularly safe and stable storage of the transport frame.

At least one fork device having two, in particular extendable forks, which are arranged in pairs, in particular parallel to one another and which are displaceable and/or extendable transversely to the longitudinal extension of the base chassis, can, for example, be arranged on the transport platform. The goods stored on the transport platform can thereby be unloaded laterally from the transport platform in a quick unloading step in a particularly simple and rapid manner. Two such fork devices can, for example, be provided on the vehicle, the fork devices being arranged, for example, parallel to one another, in particular next to one another in the direction of the longitudinal extension of the vehicle.

An operating platform for operating the industrial truck can, for example, be arranged within a space spanned by the transport frame. This allows for a particularly space-saving vehicle and a permanently clear view of an operator of the goods to be transported and/or picked.

An embodiment of the present invention is explained in greater detail below under reference to the drawings. Like reference signs thereby denote like components.

The industrial truck 1 shown schematically in each of the drawings is intended in particular for internal use and serves in particular as an order picker for the storage and retrieval of individual, stacked goods G, in particular in a high-bay warehouse L. The goods G are shown in the form of a box for a better overview, however, in the examples shown, they relate in particular to a plurality of flat wooden boards stacked on top of one another which, due to their size and weight, place particular requirements on storage, retrieval, or order picking, which requirements are met with the industrial truck 1 according to the present invention.

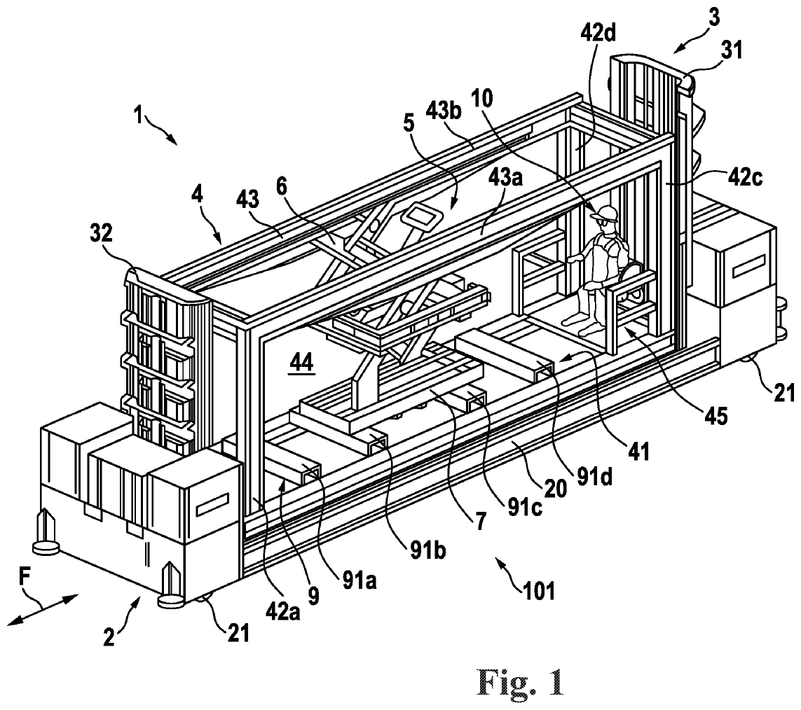

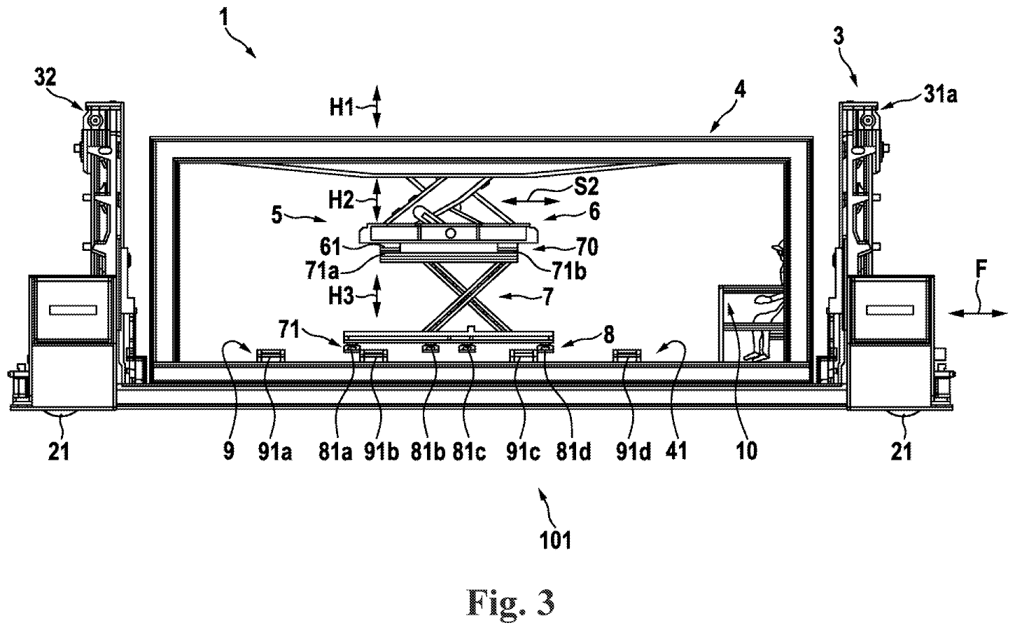

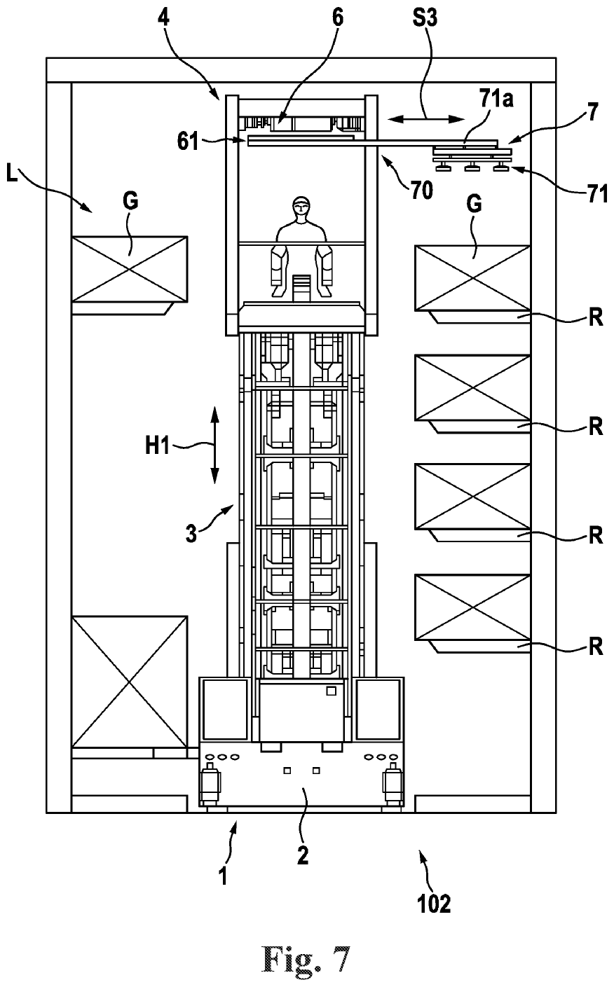

The industrial truck 1 is designed substantially the same in the respective drawings. The industrial truck 1 shown in a perspective view in FIG. 1 comprises a base chassis 2 having a chassis 20, which in the present case is guided on four wheels 21. The main directions of travel of the industrial truck 1 are in each case shown in FIGS. 3-6 in the horizontal of the image plane, which is symbolized by the arrows denoted by F. It is provided that the industrial truck 1 for the storage and retrieval of goods G can be moved in the main direction of travel F through a corridor which is laterally bounded by a shelf front with shelf compartments R open to the corridor, as can be seen in the front view of the industrial truck 1 shown in FIGS. 7-9.

On the chassis 20 of the industrial truck 1, a lifting apparatus 3 for raising or lowering a transport frame 4 is arranged, which is symbolized by the arrows denoted by H1. In the present case, the lifting apparatus 3 comprises a first lifting mast 31 and a second lifting mast 32, between which the transport frame 4 is arranged in the longitudinal extension of the industrial truck 1.

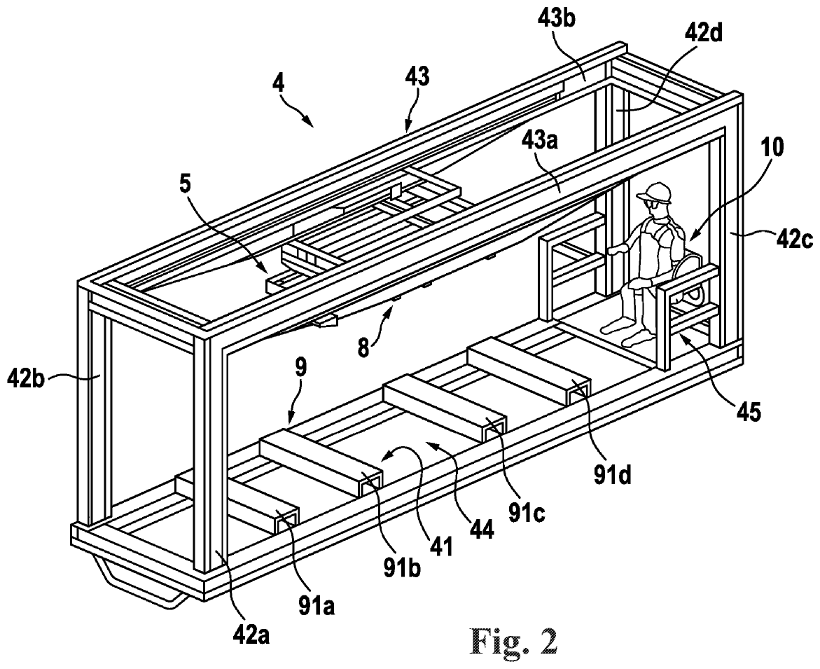

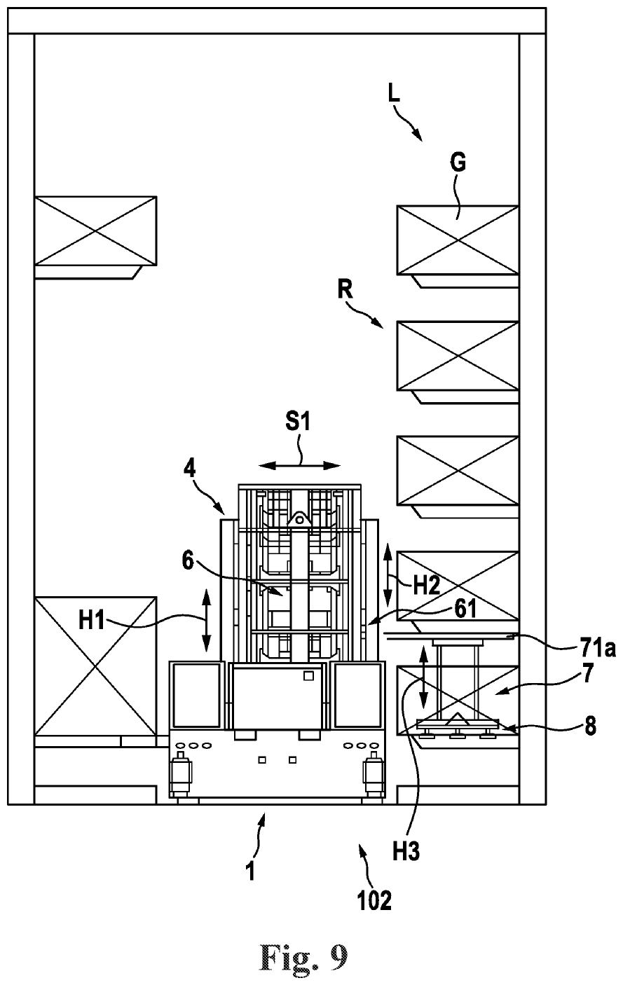

The transport frame 4, which is shown as such in FIG. 2 for a better overview, is designed in particular to be rigid or firm and, in the present case, rectangular. The transport frame 4 comprises a substantially horizontally aligned transport platform 41, supports 42a, 42b, 42c, 42d arranged in each case in a corner of the transport platform 41 and extending substantially vertically, as well as a corresponding beam 43 connecting the mutually adjacent supports 42a, 42b, 42c, 42d, in particular in the longitudinal extension of the transport frame 4 a first supporting beam 43a and a second supporting beam 43b. Within the space spanned by the transport frame 4, a first region 44 for order picking and temporary storage of goods G is provided on the transport platform 41 and a second region 45 is provided as an operating platform 10 for operating the industrial truck 1. As shown in particular in FIG. 9, in an embodiment, the entire transport frame 4 can be displaced or shifted laterally via the lifting apparatus 3 with respect to the base chassis 2, which is marked by S1.

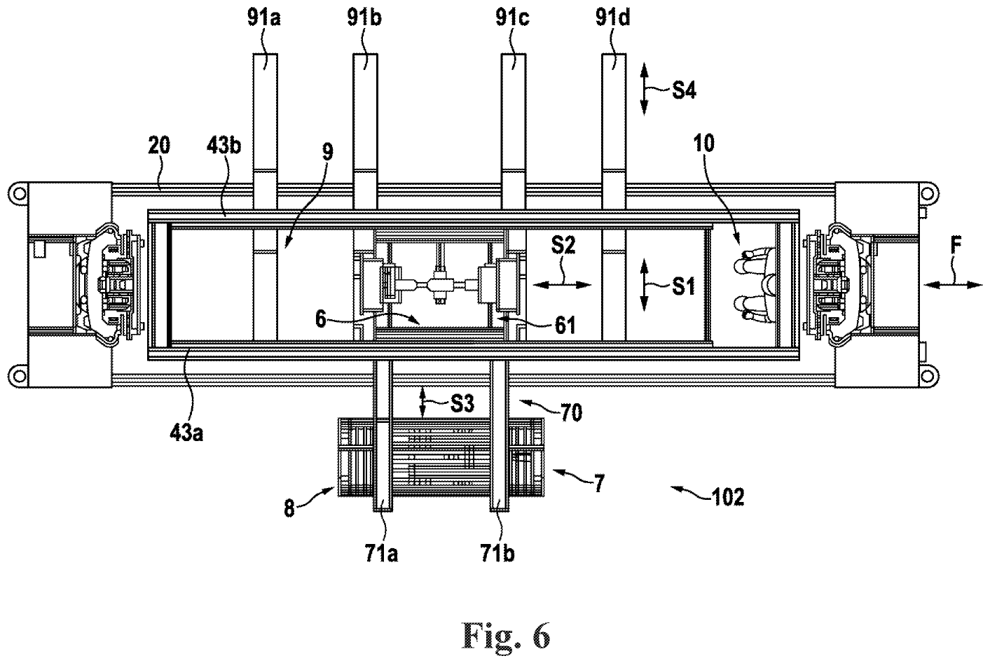

A fork device 9 is arranged on the transport platform 41 of the first region 44. The fork device 9 in the present case comprises four forks or support arms 91a, 91b, 91c, 91d which are arranged parallel to one another. As shown in particular in FIG. 6, the forks 91a, 91b, 91c, 91d can be mounted displaceably transversely to the direction of travel F in the direction S4. Goods G can as a result be deposited on the forks 91a, 91b, 91c, 91d during order picking and, in particular, for unloading via the forks 91a, 91b, 91c, 91d, laterally shifted in the direction transverse to the longitudinal extension of the industrial truck 1 at the same height. This is expedient, for example, for taking over the goods G by another system, such as a fork stack, for example, for loading a truck. A moving apparatus 5 for raising, lowering, and laterally shifting S1, S2, S3 the goods G relative to the transport frame 4 is arranged on the beam 43 of the transport frame 4, in particular on the supporting beams 43a and 43b.

The moving apparatus 5 in the present case comprises a ceiling lifting device 6 which is mounted on the two supporting beams 43a and 43b and a boom lifting gripper 7 which is mounted on the ceiling lifting device 6. In FIGS. 1-5, the moving apparatus 5 is shown in a first operating position 101 in which the boom lifting gripper 7 is surrounded by the transport frame 4. In FIGS. 6-9, the moving apparatus 5 is shown in a second operating position 102 in which, for engaging a shelf compartment R, the boom lifting gripper 7 is arranged so as to protrude at least partially, in particular laterally, beyond the contour of the transport frame 4 or so as to project from the transport frame 4. This second operating position 102 is used to pick up or deposit goods G via the boom lifting gripper 7.

The ceiling lifting device 6 comprises a scissor lifting device and is used for an initial raising, in particular for lowering the boom lifting gripper 7 with respect to the beam 43 of the transport frame 4, which is marked by H2. For this purpose, the ceiling lifting device 6 is mounted with an upper part on the two supporting beams 43a and 43b, in particular mounted displaceably in the longitudinal extension or in the main direction of travel F of the industrial truck 1, which is marked by S2. At a lower part, the ceiling lifting device 6 is connected to the boom lifting gripper 7, in particular via a load pick-up device 61. The boom lifting gripper 7 is in particular mounted on the ceiling lifting device 6 via the load pick-up device 61. The ceiling lifting device 6 is consequently designed similar to a known ceiling or bridge crane and is in particular used to distribute the goods G over the length of the industrial truck 1 or the transport frame 4 and to be able to pick them up again.

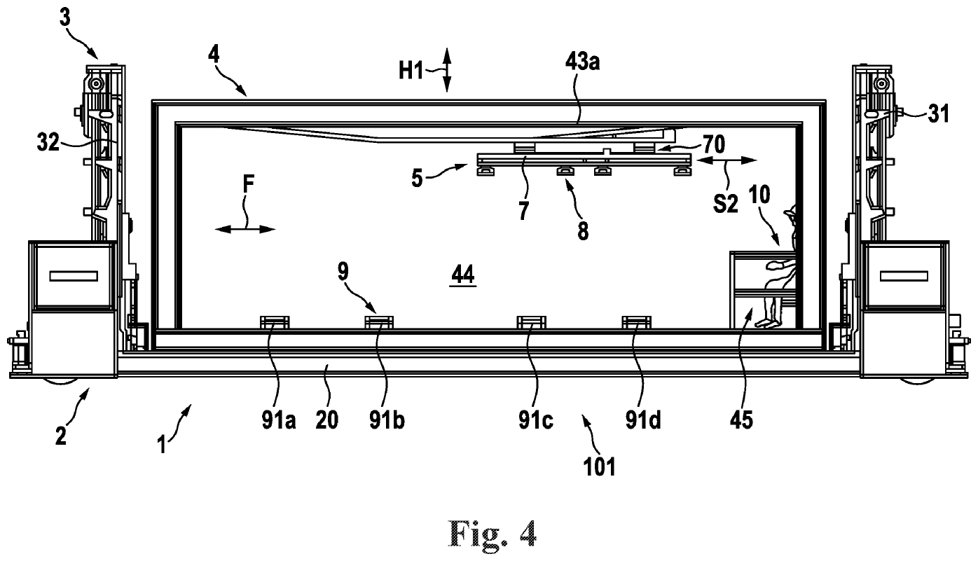

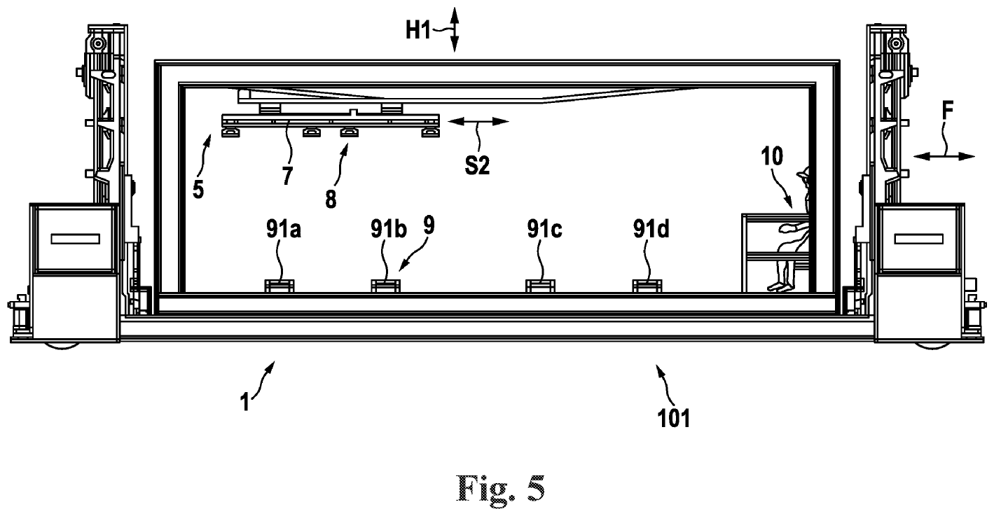

In the side view shown in FIG. 3, the ceiling lifting device 6 and the boom lifting gripper 7 are completely extended, in particular lowered. In this operating position, an item of goods G located directly in the region of the transport platform 41 can, for example, be picked up or deposited via a load pick-up device 71 arranged on the boom lifting gripper 7. In the side view shown in FIG. 4, the ceiling lifting device 6 is completely retracted and thus completely arranged between the supporting beams 43a, 43b, and is therefore at least partially covered by the first supporting beam 43a in the present view. The ceiling lifting device 6, which is mounted displaceably in the main direction of travel F of the industrial truck 1, is arranged in the present case, for example, above a first fork device 9 or a first pair of forks 91c, 91d. In the side view shown in FIG. 5, the ceiling lifting device 6 is also completely retracted and is arranged between the supporting beams 43a, 43b, but in the present case above a second fork device 9 or a second pair of forks 91a, 91b. The forks 91a, 91b, 91c, 91d can in particular be mounted so as to be displaceable perpendicular to the image plane.

The boom lifting gripper 7 also comprises a scissor lifting device and is used for an additional lift, in particular for the complete lowering of goods down to the transport platform 41, which is marked by H3. For this purpose, the upper part of the boom lifting gripper 7 is mounted on the ceiling lifting device 6, in particular on a load pick-up device 61 of the ceiling lifting device 6, in particular so as to be displaced in a transverse extension or perpendicular to the main direction of travel F of the industrial truck 1, which is marked by S3. The displaceability of the boom lifting gripper 7 is in this case provided by device 70, in particular via a support rail device 70 with two displaceable and/or extendable support arms 71a, 71b, in particular telescopic support arms. The support arms 71a, 71b are in this case fastened with a stationary part to the load pick-up device 61 and have a movable part on which the scissor lifting device of the boom lifting gripper 7 is fastened. As a result, the raising H3 can take place in a position of the boom lifting gripper 7 that is in particular laterally offset in relation to the ceiling lifting device 6. In this second operating position 102, which is in particular shown in FIGS. 6-9, the boom lifting gripper 7 can raise or lower the load pick-up device 71 relative to the load pick-up device 61 or the support rail device 70, in particular for picking up or depositing goods G. A permanently unobstructed view of the first region 44 can as a result be provided from the operating platform 10. The load pick-up device 71 for picking up and depositing goods G is arranged in a lower region of the boom lifting gripper 7.

In the present case, the load pick-up device 71 is designed as a suction unit 8 with, in the present case, four pairs of suction cups 81a, 81b, 81c, 81d for carrying the goods G via negative pressure. The pairs of suction cups 81a, 81b, 81c, 81d each comprise two downwardly directed suction cups, which are placed on a, for example, flat surface of the uppermost stored item of goods G, in particular a wooden board, then negative pressure is formed in the bell of the suction cups via the suction unit 8, and the item of goods G stored at the top can be raised, held and/or carried by the load pick-up device 71 by the negative pressure formed. To release the connection to the item of goods G, the negative pressure can be eliminated after the item of goods G has been deposited so that the suction cups are again released from the item of goods G.

FIG. 7 shows the moving apparatus 5 in a second operating position 102, which shows the industrial truck 1 operated in a corridor between two high racks L with a transport frame 4 raised via the lifting apparatus 3 via the lifting masts 31, 32 to the level of a shelf compartment R to be targeted. The ceiling lifting device 6 of the moving apparatus 5 is retracted between the two supporting beams 43a, 43b in the state shown in FIG. 7, wherein the load pick-up device 61 with the support rail device 70 arranged thereon can be seen on an underside of the ceiling lifting device 6. The support arms 71a, 71b to be assigned to the support rail device 70 are in the present case extended laterally so that the boom lifting gripper 7 is arranged laterally shifted relative from the transport frame 4, in particular in a shelf compartment R above an item of goods G.

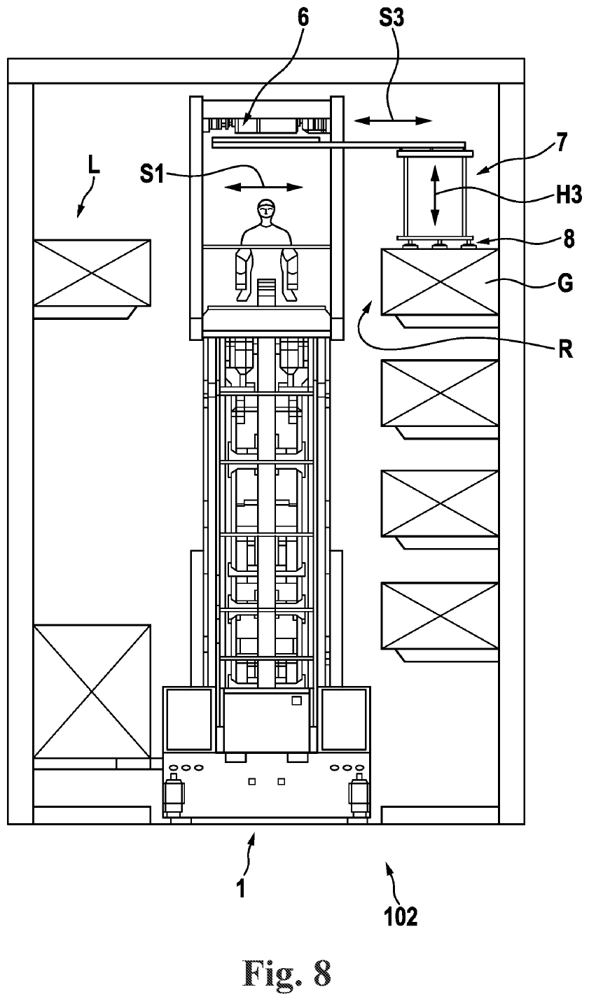

As can be seen in FIG. 8, in a step following the state shown in FIG. 7, the scissor lift of the boom lifting gripper 7 can be extended, so that the load pick-up device 71 comprising the suction unit 8 comes to rest against the upper side of the item of goods G and thereby the item of goods G can be raised and carried so that it can be retrieved from the shelf compartment R and guided to the transport platform 41. In order to make this path as short and in particular as safe as possible, the entire transport frame 4, as shown in the example in FIG. 9, can be shifted by a distance S1 in the direction of the shelf compartment R. The view of an operator located in the operating platform 10 of both the contact region between the load pick-up device 71 and the good G and the first region 44 of the transport frame 4 is thereby always unobstructed so that particularly safe and fast order picking is possible. For the safe and advantageous distribution of the load or goods G on the transport platform 41, the boom lifting gripper 7 can be shifted together with the goods G in the longitudinal direction of the transport frame 4 via the ceiling lifting device 6 which is displaceably mounted in the direction of the main direction of travel F.

Another example of picking is shown in FIG. 9, in particular picking up or depositing an item of goods G in a particularly low-lying position, as is the case, for example, when a single flat item of goods G is arranged in a lowermost shelf compartment R. The transport frame 4 is moved to the lowest position thereof, the ceiling lifting device 6 is completely extended or lowered within the transport frame, whereby the load pick-up device 61 with the support rail device 70 arranged thereon and the laterally extended support arms 71a, 71b can be seen on an underside of the ceiling lifting device 6. In this laterally extended position, the boom lifting gripper 7 is also completely extended so that the suction unit 8 comes to rest against the upper side of the item of goods G and the item of goods G can thereby be raised and carried from a bottom shelf compartment R for storage or retrieval.

It should be clear that the scope of protection of the present invention is not limited to the embodiment described. In particular, the structure of the industrial truck can be modified without changing the essence of the present invention. Any kind of goods can of course also be transported with the present invention, not just flat panel elements. The present invention is not limited to embodiments described herein; reference should also be had to the appended claims.

### LIST OF REFERENCE NUMERALS

1 Industrial truck
10 Operating platform
2 Base chassis
20 Chassis
21 Wheels
3 Lifting apparatus
31 First lifting mast
32 Second lifting mast
4 Transport frame
41 Transport platform
42a Support
42b Support
42c Support
42d Support
43 Beam
43a First supporting beam
43b Second supporting beam
44 First region
45 Second region
5 Moving apparatus
6 Ceiling lifting device
61 Load pick-up device
7 Boom lifting gripper
70 Rail support device
71 Load pick-up device
71a Support arm
71b Support arm
8 Suction unit
81a Pair of suction cups
81b Pair of suction cups
81c Pair of suction cups
81d Pair of suction cups
9 Fork device/First fork device/Second fork device
91a Fork/Support arm
91b Fork/Support arm
91c Fork/Support arm
91d Fork/Support arm
101 First operating position
102 Second operating position
G Goods
L High-bay warehouse
H1 Height, raising, lowering
H2 Height, raising, lowering
H3 Height, raising, lowering
S1 Offset, shifting
S2 Offset, shifting
S3 Offset, shifting
S4 Offset, shifting
F Main direction of travel
R Shelf compartment

What is claimed is:

1-12. (canceled)

13: An industrial truck comprising:
a base chassis;
a rigid transport frame comprising at least one transport platform on which goods are transportable, and at least one supporting beam which is arranged above the at least one transport platform;
a lifting apparatus which is configured to raise, to lower and to laterally shift the rigid transport frame; and
a moving apparatus which is configured to raise, to lower and to laterally shift the goods at least relative to the rigid transport frame, the moving apparatus being mounted on the at least one supporting beam.

14: The industrial truck as recited in claim 13, wherein,
the moving apparatus comprises a boom lifting gripper,
the boom lifting gripper comprises a load pick-up device which is configured to pick up and to deposit the goods,
the load pick-up device comprises a suction unit, and
the suction unit comprises suction cups which are configured to carry the goods via a negative pressure.

15: The industrial truck as recited in either claim 14, wherein,
the moving apparatus further comprises a shifting device for laterally shifting the goods, and
the moving apparatus is further configured to raise or to lower the goods relative to the shifting device.

16: The industrial truck as recited in claim 13, wherein,
the moving apparatus further comprises a ceiling lifting device and a boom lifting gripper,
the ceiling lifting device is configured to raise, to lower and to laterally shift at least the boom lifting gripper, and
the boom lifting gripper is configured to additional raise, to additionally lower and to additionally laterally shift the goods.

17: The industrial truck as recited in claim 16, wherein,
the ceiling lifting device is mounted on the at least one supporting beam, and
the boom lifting gripper is mounted on the ceiling lifting device.

18: The industrial truck as recited in claim 16, wherein,
the base chassis comprises a longitudinal extension and a transverse extension,
the ceiling lifting device is configured to be movable at least relative to the rigid transport frame in a direction of the longitudinal extension of the base chassis, and
the boom lifting gripper is configured to be movable at least relative to the rigid transport frame in a direction of the transverse extension of the base chassis.

19: The industrial truck as recited in claim 16, wherein the ceiling lifting device and the boom lifting gripper each comprise a scissor lifting device.

20: The industrial truck as recited in claim 13, wherein the rigid transport frame is configured to be movable at least laterally relative to the base chassis.

21: The industrial truck as recited in claim 13, wherein the at least one supporting beam is arranged via at least one support at a specific distance above the at least one transport platform and is rigidly connected to the at least one transport platform.

22: The industrial truck as recited in claim 13, wherein,
the lifting apparatus comprises a first lifting mast and a second lifting mast which is arranged opposite to the first lifting mast in a longitudinal extension of the industrial truck, and
the rigid transport frame is arranged between the first lifting mast and the second lifting mast.

23: The industrial truck as recited in claim 13, further comprising:
at least one fork device comprising two forks which are arranged as a pair, the at least one fork device being arranged on the at least one transport platform,
wherein,
the base chassis comprises a longitudinal extension, and
the two forks are configured to be at least one of displaceable and extendable transversely to the longitudinal extension of the base chassis.

24: The industrial truck as recited in claim 23, wherein the two forks which are arranged as the pair are further arranged parallel to one another.

25: The industrial truck as recited in claim 13, further comprising:
an operating platform for operating the industrial truck, the operating platform being arranged within a space which is spanned by the rigid transport frame.

26: The industrial truck as recited in claim 13, wherein the industrial truck is an order picker.
